(19) United States
(12) Patent Application Publication
(10) Pub. No.: US 2017/0065473 A1
(43) Pub. Date: Mar. 9, 2017

(54) Patient Inflatable Positioners and Positioner Bags

(71) Applicant: James R. Scott, Greendale, WI (US)

(72) Inventor: James R. Scott, Greendale, WI (US)

(21) Appl. No.: 15/234,071

(22) Filed: Aug. 11, 2016

Related U.S. Application Data
(63) Continuation of application No. 14/995,363, filed on Jan. 14, 2016.
(60) Provisional application No. 62/389,858, filed on Mar. 11, 2016.
(60) Provisional application No. 62/386,344, filed on Nov. 28, 2015.
(60) Provisional application No. 62/283,684, filed on Sep. 8, 2015.

(51) Int. Cl. A61G 7/057

(52) U.S. Cl. CPC A61G 7/05769; A61G 2007/05784; A61G 2203/10; A61G 2203/70

(57) ABSTRACT

An inflatable positioner includes a low coefficent of friction (COF) on a top surface and a high COF on a bottom surface. The inflatable positioner is slid under the patient and then inflated by an air pump. At least two positioners can be inflated and deflated with the air pump and a timer. A non-inflatable positioner may be inserted into a positioner bag with a high COF outer surface. An inflatable gusseted or non-gusseted positioner may be created from a single sheet of material or from two sheets of material. A tail may be attached to a positioner to allow thereof to be pulled under a patient's body. A strap may be attached to the positioner to allow the positioner to be secured to another object. The sheet of material may be breathable or non-breathable. A plurality of breathable vent perforations are formed through the non-breathable sheet of material.

### CROSS-REFERENCES TO RELATED APPLICATIONS

This is a continuation-in-part application, which claims the benefit of provisional application No. 62/389,858, filed on Mar. 11, 2016 and which takes priority from patent application Ser. No. 14/995,363, filed on Jan. 14, 2016, which claims the benefit of provisional application No. 62/177,012 filed on Mar. 24, 2015; provisional application No. 62/283,684 filed on Sep. 30, 2015; and provisional application No. 62/386,344 filed on Nov. 30, 2015. Provisional application Nos. 62/177,012, 62/283,684 and 62/386,344, 62/389,858 and patent Ser. No. 14/995,363 are hereby incorporated by reference into this application in their entirety.

### BACKGROUND OF THE INVENTION

1. Field of the Invention

The present invention relates generally to healthcare and more specifically to patient inflatable positioners and positioner bags, which facilitate patient positioning; limb positioning; ducubitus ulcer prevention and treatment without logrolling or lifting the patient and is within the ANA's and other organizations safe patient handling exertion guidelines.

2. Discussion of the Prior Art

One embodiment of the present invention is a thin deflated positioner with a tail, which is placed under a patient lying on a mattress by grabbing the tail; pressing down on the mattress; and pushing the tail partly under the patient (preferably at least to the patient's spine). Then the caregiver can go to the other side of the patient and grab the tail and pull the positioner into place. Using the same method with a thick standard foam rubber positioner or one utilizing a foam rubber base, such as in patent application 2015/0040326 A1 or U.S. Pat. No. 6,216,299 B1, would require exceeding the maximum exertion force guidelines of the ANA and other safe patient handling organizations. These former disclosures require lifting, or log rolling the patient, or the patient to get on the device with assistance. Many patients that need positioners are incapable of assisting the caregiver.

Single patient use positioners need to be low cost. The body of this invention can be made simply with one or two sheets of material joined at only a part of, or around the entire perimeter thereof. Pillow like positioners can be made without gussets. Caregivers often need to elevate parts of a patient's body 4 to 6 inches and sometimes more. Elevating parts of a patient (especially the trunk) 4 to 6 inches with a non-gusseted pillow shaped inflatable positioner takes space. About half the positioner will stick out from under the patient, and possibly more than 8 inches. A positioner with one gusset can be made with one sheet of material and be wedge shaped. It will take up less room and may not stick out from under the patient at all. Large patients may take up most of the width of a hospital bed so gusseted positioners can be an advantage. More gussets can be used to make different shaped positioners with one sheet of material. The body and tail of the positioner can be made from one continuous sheet of material or the tail can be a different sheet that is attached at the factory or in the field.

Materials such as micropore polyethylene or polypropylene film, or laminates of spunbond, meltdown, and spunbond are inexpensive, and can be strong enough for positioners. Micropore materials have perforations so small that they breathe, but often do not vent at pressures used to inflate positioners, which is usually less than one psi. There are other applicables of inexpensive films or coated materials that do not breathe but can be perforated (vented). Perforations around 0.5 mm allow air to escape and blow over a patient or the surface that the patient is lying on. Gore-Tex is not preferred due to its relatively high cost. The invention embodiments can be made from one continuous sheet of flat material, one sheet of tube like material, or two sheets of flat material. Whether the material is one sheet flat, a tube, or two sheets depends on the perforation and assembly machines as the goals are functionality and low cost. No foam or internal compressible fiber filling is required.

One problem with positioners is that they tend to creep out of place and out from under a patient. One embodiment of this invention includes an anchor attached to the positioner tail to prevent the positioner from moving out from under the patient. The anchor may be made out of an inflated bag, and inflatable bag, foam rubber, other material soft enough not to injure but firm enough to resist pulling under the patient. An inflatable bag can be factory attached to the positioner tail and pushed under the patient as previously described. An inflated bag, foam rubber, or other type of anchor is better field attached after the tail is placed under the patient. The anchor may be attached by adhesive such as tape, by hook and loop fasteners, by snaps, by wrapping the tail around it and securing the tail to itself, or by other suitable means. Preferably when secured, one edge of the anchor will be against the side of the patient opposite the positioner and its thickness will prevent it from being pulled under the patient. The anchor moves with the patient and can be used on an exam or x-ray table. The anchor does not require a bed frame to hold the positioner in place. Another embodiment of this invention is for the tail to be made convenient to tether to the patient's bed frame to hold the positioner body in place.

Bedridden and acutely injured or weak patients often cannot turn or move themselves to relieve pressure on some parts of their body. The constant pressure may cause decubitus ulcers. Decubitus ulcers also form faster on damp skin. To prevent or treat ducubitus ulcers, caregivers turn patients about every two hours and keep them in position with positioners that are often made of foam rubber or pillows. Caregivers also attempt to keep the patient's skin cool and dry by using materials that let it breathe or products that blow air across it. Positioners are also used to relieve pressure sores once formed. Caregivers have to position patients, their limbs or head for diagnostics such as x-rays. Some positioners are wedge shaped, but others are cylindrical, half cylinder, cube, hollowed rectangle, circular etc.

Moving or rolling the patient to get wedges under them, takes a lot of effort and causes caregiver injuries. A thin un-inflated positioner is much easier to put under a patient than a foam positioner, and the ability to inflate and deflate at any time means the positioner doesn't have to be removed and reinserted elsewhere. The same positioner should not be used between patients, unless it is thoroughly cleaned to prevent spreading diseases, but using a new positioner each time is costly.

Positioners must be put under a patient, which is difficult task. It is difficult to insert thick or thin positioners with a high coefficient of friction, under a patient's trunk or a bariatric patient's limbs. Once under the patient, positioners are prone to move (sometimes slipping out from under the patient) over time. Positioners that are placed under a patient are also usually under linen and don't come in direct contact with the patient. Positioners and positioner bags that under a patient for a short period of time and are separated from the patient by linen do not have to breathe (allow air or water vapor to pass through them). Some positioners are used to stabilize limbs, necks, hands, feet, or other body parts. These positioners may be in direct contact with the patient's skin. Preferably, positioners in direct contact with a patient's skin breathe or provide a skin drying action.

The positioners will often be used to prevent or treat bedsores. This will be done by placing the positioners under patients in areas without or not prone to bedsores. Unfortunately, when positioners are in place they apply pressure to some areas in order to relieve pressure from sensitive areas. The positioners have to be periodically moved to another area of the body to prevent causing bedsores. Moving the positioners takes caregivers time and effort. This invention allows a caregiver to put one or more positioners in place and inflate/deflate them periodically and automatically. This allows the caregiver to treat the patient with minimum effort. U.S. Pat. No. 5,603,133 to Vrzalik discloses an apparatus for alternating pressure of a low air loss patient support system (mattress) that is different than a positioner.

Radiology Technicians often need to position patients or parts thereof in order to take x-rays or other diagnostic images. If they use a common foam rubber wedge, they need to use a new one for each patient, protect it from germs, or clean it, which is difficult. Otherwise they risk contaminating patients with other patient germs. Additionally, inserting a positioner under a patient and keeping it in place can be difficult, tiring, and may cause caregiver injuries. Inexpensive bags to make insertion easier, keep the positioners clean and in place, and positioners that are thin when inserted and expand afterwards, and positioners that dry patients skin are desirable.

Acute care nurses and their aides need to prevent or treat bed sores, which is often done by using positioners to remove pressure from certain areas of a patients' body. The positioners elevate certain areas of a patient's body enough so that the target area (often hips or tailbone) does not bear weight or have pressure on the skin. The positioners have to be removed or moved to a different spot frequently or the pressure they cause on the skin will create bedsores. In such cases, the treatment creates the malady. America's patient population is getting heavier so there are more bariatric patients each year. Inserting positioners takes time and causes too many caregiver injuries.

Positioners are used in many areas of patient care. They are costly and contribute to landfill. Provisional patent No. 62/177,012 includes embodiments of bags and inflatable positioners that have one side made of a low COF material and the other side a high COF material. Provisional Patent No. 62/386,344 discloses that it may be more economical for a bag maker to make two different bags. One bag would have high COF surfaces and the other low COF surfaces. Two bags (one with high COF surfaces and one with low COF surfaces may also perform better in some instances. It may also be more economical to make all sides of inflatable positioners from the same material.

Caregivers in some areas of a health care facility may prefer to use a non-inflatable positioner made of foam, gel, or other material when positioning a head or a limb. The positioner would be put into a high COF bag. The high COF bag would then be put into a low COF bag. The low COF bag makes it easier to slide the positioner under the patient. Once under the patient, the low COF bag would be removed exposing the high COF bag. The high COF bag performs two functions. It keeps the positioner clean, protecting it from germs so it can be reused, and holds it in place. The high COF bag should be kept sealed as long as it is used with the same patient. The low COF bag can be reused with the same patient by putting the high COF bag and positioner in it again. Both the high and low COF bags should be properly discarded between patients.

Caregivers in some areas of a health care facility may prefer inflatable positioners. A thin flat positioner is easier to put in place than a thick one. A deflated positioner could be put in place and then inflated. It could be inflated and deflated several times without moving. The air pump with a timer described in provisional patent No. 62/283,684 makes inflation automatic, which allows caregivers more time for other duties. The inflatable high COF positioner is put into the slippery low COF bag during insertion and then the low COF bag is removed.

Caregivers are often injured from moving patients. Moving includes but is not limited to lateral transfers; repositioning (moving up in bed); turning; logrolling a patient that is laying down; and/or turning and sliding one that is sitting. Logrolling is often necessary to get prior art positioners under the patient. The American Nurses Association and other safe patient handling guidelines recommend that caregivers do not individually exert more than 35 pounds of force in moving patient. New studies show that logrolling patients weighing more than 100 pounds exceeds the recommended safe patient handling guidelines.

U.S. Pat. No. 8,850,634 to Ponsi et al. (Ponsi) discloses an apparatus and system for turning and positioning a patient. Ponsi describes a non-inflatable device with a “high” coefficient of friction (COF) bottom surface and a “low” COF top surface. A table in columns 9 and 10 show nylon fabric's “low” COF to be 0.314 when on a hard surface covered by a poly/cotton fabric. Assuming the COF is constant as the weight increases, two people each applying identical force of 35 pounds in a very efficient manner (70 pounds total) could safely move a patient weighing a maximum of 222.9 pounds on a level poly/cotton fabric covered hard surface. U.S. Pat. No. 8,789,533 to Steffens et al. discloses a method for turning, positioning, and putting foam wedge positioners under a patient. The disclosed method requires moving the patient up the wedge i.e.: claim 1, lines 25-30. If 70 pounds of force will move a maximum 222.9 weight patient on a level poly/cotton fabric covered hard surface, that same 70 pounds of force will move much less weight up a wedge ramp.

Patent publication number 2013/0205495 includes FIGS. 7-8d, which disclose log rolling a patient to insert an incontinence pad under him. The method of placing pads, linens, patient moving devices, positioners and other items, under patients has been used for many years and is well known in the art. However the caregiver exertion (force) required to logroll most adults (over 100 pounds) exceeds safety guidelines according to some experts and recent studies. Another problem is that some patients should not be log rolled due to medical conditions such as a broken hip, broken shoulder or spinal problems. The present invention does not require log rolling to insert a positioner under a patient.

Accordingly, there is a clearly felt need in the art for patient inflatable positioners and positioner bags, which facilitate patient positioning; limb positioning; ducubitus ulcer prevention and treatment without logrolling or lifting the patient and within the ANA's and other organizations safe patient handling exertion guidelines.

### SUMMARY OF THE INVENTION

The present invention provides patient inflatable positioners and positioner bags, which facilitate patient positioning; limb positioning; ducubitus ulcer prevention and treatment without logrolling or lifting the patient. The inflatable positioner can be slid under the patient and into place while deflated and without moving or logrolling the patient. At least one inflatable positioner is connected to an air pump and inflated. The inflatable positioner may have a wedge shape, but other shapes may also be used. An inflatable positioner includes a low coefficent of friction (COF) on a top surface and a high COF on a bottom surface. A second embodiment of the inflatable positioner includes high COF surfaces inside a removable low COF bag. A third embodiment is an inflatable positioner having high or low COF surfaces with pressure sensitive adhesive on some surfaces to hold it in place. A fourth embodiment is any of the aforementioned inflatable positioners with a plurality of micro holes for helping to dry a patient's skin. The plurality of micro holes would leak a little air, while allowing the positioner to be inflated. At least one inflatable positioner is slid under the patient and then inflated by the air pump. At least one positioner can be inflated and deflated at any time such as on a two hour time schedule. Alternatively, a pressure sensitive adhesive may be added to the bottom surface of the inflatable positioner or replace the high COF on the bottom surface of the inflatable positioner.

The inflatable positioner may be contained in a positioner bag. The positioner bag is large enough to completely receive the positioner and be sealed around the positioner. The positioner bag includes a low COF top surface and a high COF bottom surface. The positioner bag protects the positioner from contamination. The positioner bag is discarded after each patient use, instead discarding a more expensive positioner. Further, the positioner bag may be fabricated from a breathable material coated on at least one side to be a germ barrier. The breathable material may be a woven or non-woven fabric. An inside surface of the positioner bag would have a low COF impervious coated surface or a low COF impervious material placed on an inside of the positioner bag to allow easy insertion of the inflatable positioner.

A positioner tail may be extended from a bottom of the inflatable positioner. The positioner tail is used to help insert the inflatable positioner under a patient and keep the inflatable positioner in place. The positioner tail is preferably inserted under the patient first and acts as an extension of the inflatable positioner. The positioner tail could also be inflatable. If the inflatable positioner includes a positioner tail, a positioner bag must be extended to cover the positioner tail.

A time operated inflation system preferably includes an air pump, a timer and a diverter valve. The time operated inflation system is used to inflate at least one positioner but could inflate two or more inflatable positioners. The diverter valve includes one inlet and at least two outlets. The inlet of the diverter valve is connected to an outlet of the air pump. The timer provides electrical power to the diverter valve to shuttle the diverter valve from a first position to a second position. When in the first position, the air pump inflates a first inflatable positioner through a first outlet of the diverter valve. When in the second position, the air pump inflates a second inflatable positioner (if connected) through a second outlet of the diverter valve. The timer may be programmed to provide a preferable inflation time between 10 minutes to 3 hours. It is preferable to have an alarm sound if the air pressure to one of the inflatable positioners is too low.

Non-inflatable positioners may be preferred over inflatable positioners by some caregivers or health care facilities, when placed under the head or limbs. The non-inflatable positioners are made of foam, gel, or other materials. The non-inflatable positioner is inserted into a positioner bag with an outer surface having a high COF. The high COF positioner bag is inserted into a positioner bag having an outer surface with a low COF. The low COF positioner bag is easier to slide under a patient. After the low COF positioner bag is inserted under the patient, the low COF positioner bag is removed to expose the high COF bag. The high COF positioner bag performs two functions. First, the high COF positioner bag keeps the non-inflatable positioner clean, protecting it from germs so it can be reused. Second, the high COF outer surface of the high COF positioner bag holds it in place. The high COF positioner bag should be kept sealed as long as it is used with the same patient. The low COF positioner bag can be reused with the same patient by re-inserting the high COF positioner bag and the non-inflatable positioner. The high and low COF positioner bags should be properly discarded between patients. The high and low COF positioner bags may also be used with inflatable positioners. The positioner bags are preferably fabricated from an economical material, because they are discarded after use with only one patient.

Many non-inflatable positioners are made out of compressible foam. A compressed non-inflatable positioner is easier to insert under a patient than one of full size. However, the compressed non-inflatable positioner needs to expand once under the patient. A compressible positioner bag includes a port, which allows air to be evacuated through the port. The port includes a seal cap for sealing the port. The non-inflatable positioner is inserted into the compressible positioner bag; the seal cap is removed from the port; and air is evacuated from the compressible positioner bag through the port with a vacuum device. The port is covered with the seal cap; the compressible positioner bag is inserted under the patient; and the seal cap removed from the port. The compressible non-inflatable positioner then expands to its normal size inside the compressible positioner bag.

A sheet of material is gusseted on one end. Three open edges of the sheet of material are seamed to form a gusseted positioner body. The gusseted positioner body may also be formed from two sheets of material. An inflation inlet is added to the gusseted positioner body at a gusset end to create a gusseted positioner. The gusseted positioner when inflated has a wedge shape. A gusseted positioner with tail includes the gusseted positioner and a tail. The tail preferably extends from a non-gusseted end of the gusseted positioner with tail. The tail includes a tail portion and an anchor portion. One end of the tail portion extends from the non-gusseted end and the anchor portion extends from an opposing end of the tail portion.

A sheet of material is folded over and seamed on three open sides to create a positioner body. An inflation inlet is added to positioner body to create an inflatable positioner. The positioner when inflated has a substantial pillow shape. A positioner with a tail includes the inflatable positioner and a tail. The tail includes a tail portion and an anchor portion. One end of the tail portion preferably extends from an end opposite the inflation inlet and the anchor portion extends from an opposing end of the tail portion. A strap may be attached to any inflatable positioner instead of the tail. The strap may be secured to another object. The gusseted positioner body or the positioner body may be fabricated from a breathable material or a non-breathable material. If from a non-breathable material, a plurality of vent perforations are preferably formed in the position bodies.

Accordingly, it is an object of the present invention to provide patient inflatable positioners and positioner bags, which make patient positioning more efficient, less expensive and with a minimum effort.

It is further object of the present invention to provide patient inflatable positioners and positioner bags, which do not require log-rolling or moving the patient to get them in position.

Finally, it is another object of the present invention to provide patient inflatable positioners and positioner bags, which are within the ANA's and other organizations safe patient handling exertion guidelines.

These and additional objects, advantages, features and benefits of the present invention will become apparent from the following specification.

### BRIEF DESCRIPTION OF THE DRAWINGS

FIG. 1 is a perspective view of a wedge shaped inflatable positioner connected to an air pump in accordance with the present invention.

FIG. 2 is a side view of a patient resting on an inflatable positioner having a shape of a half cylinder in accordance with the present invention.

FIG. 3 is a perspective view of an inflatable positioner retained in a positioner bag in accordance with the present invention.

FIG. 4 is a bottom view of an inflatable positioner with a plurality of pressure sensitive adhesive strips retained on a bottom thereof in accordance with the present invention.

FIG. 5 is a perspective view of an inflatable positioner with a positioner tail in accordance with the present invention.

FIG. 6 is a perspective view of a time operated inflation system in accordance with the present invention.

FIG. 7 is a perspective view of a non-inflatable positioner retained in two layers of positioner bags in accordance with the present invention.

FIG. 8 is a perspective view of an inflatable positioner with a positioner tail retained in a tail positioner bag in accordance with the present invention.

FIG. 9 is a perspective view of a compressible non-inflatable positioner retained in a compressible positioner bag with a vacuum device about to apply a vacuum to the compressible positioner bag in accordance with the present invention.

FIG. 10 is a perspective view of a compressible non-inflatable positioner retained in a compressible positioner bag after having a vacuum applied thereto in accordance with the present invention.

FIG. 11 is a side view of a single sheet of material before it is assembled to make a gusseted positioner without illustrating an air inlet in accordance with the present invention.

FIG. 12 is a side view of a gusseted positioner body after being assembled and inflated in accordance with the present invention.

FIG. 13 is an end view of an inflated gusseted positioner in accordance with the present invention.

FIG. 14 is a side view of an inflated gusseted positioner with a tail in accordance with the present invention.

FIG. 15 is a side view of an inflated gusseted positioner with a tail and an end view of a patient's torso resting on the inflated gusseted positioner with a tail in accordance with the present invention.

FIG. 16 is a side view of a folded over single sheet of material before it is assembled to make a pillow shaped positioner without illustrating an air inlet in accordance with the present invention.

FIG. 17 is a side view of an inflated pillow shaped positioner with a tail in accordance with the present invention.

FIG. 18 is a top view of a positioner with a strap that can be tethered to a bed frame or other object in accordance with the present invention.

FIG. 19 is a side view of two sheets of material before assembly to create a gusseted positioner body without illustrating an air inlet in accordance with the present invention.

FIG. 20 is a side view of two sheets of material before assembly to create a pillow shaped positioner body without illustrating an air inlet in accordance with the present invention.

### DETAILED DESCRIPTION OF THE PREFERRED EMBODIMENTS

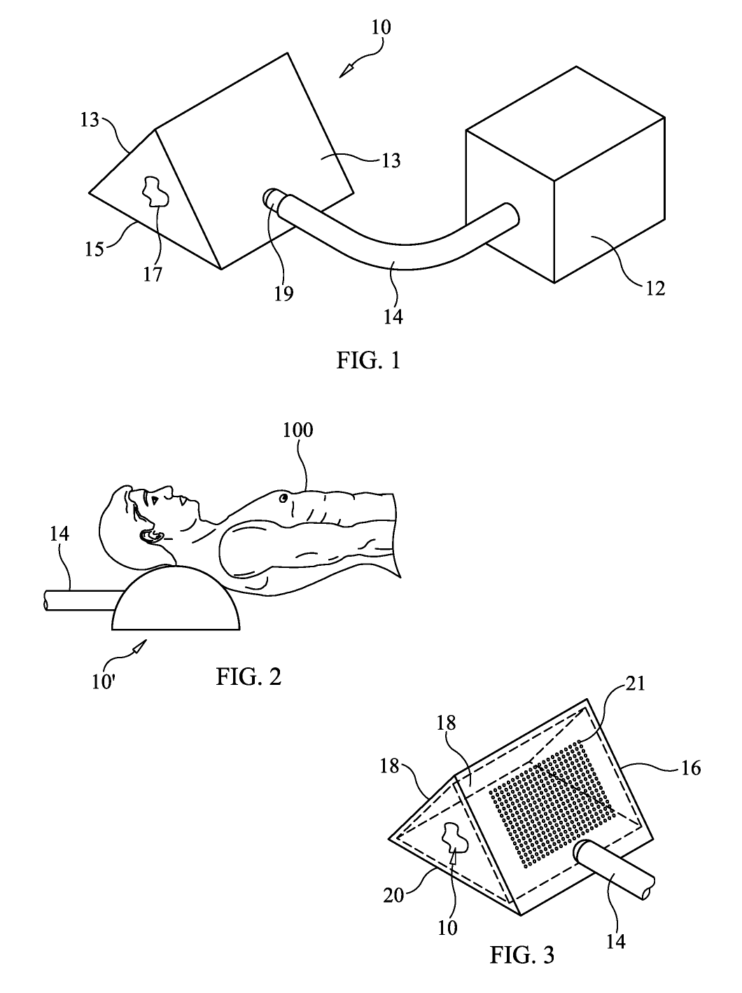

With reference now to the drawings, and particularly to FIG. 1, there is shown a perspective view of an inflatable positioner 10 connected to an air pump 12 through an air hose 14. The inflatable positioner 10 includes at least one top surface 13 and a bottom surface 15 defining an internal cavity 17. The internal cavity 17 is capable of retaining pressurized air through an inlet 19. The inflatable positioner 10 is shown as having a wedge shape, but other shapes may also be used. The inflatable positioner 10 preferably includes a low coefficent of friction (COF) formed on a top surface 13 and a high COF on a bottom surface 15. The bottom surface 15 will resist movement relative to a mattress or a bed sheet. The top surface 15 will be slippery relative to skin of a patient 100 (or a bedsheet between the inflatable positioner 10 and the skin) to facilitate positioning of the inflatable positioner 10 relative to the patient 100. With reference to FIG. 2, an inflatable positioner 10′ having a half cylinder shape is first deflated as slid under the patient 100. The inflatable positioner 10′ is then inflated with the air pump 12. A portion of a patient 100 is supported by an inflated inflatable positioner 10′.

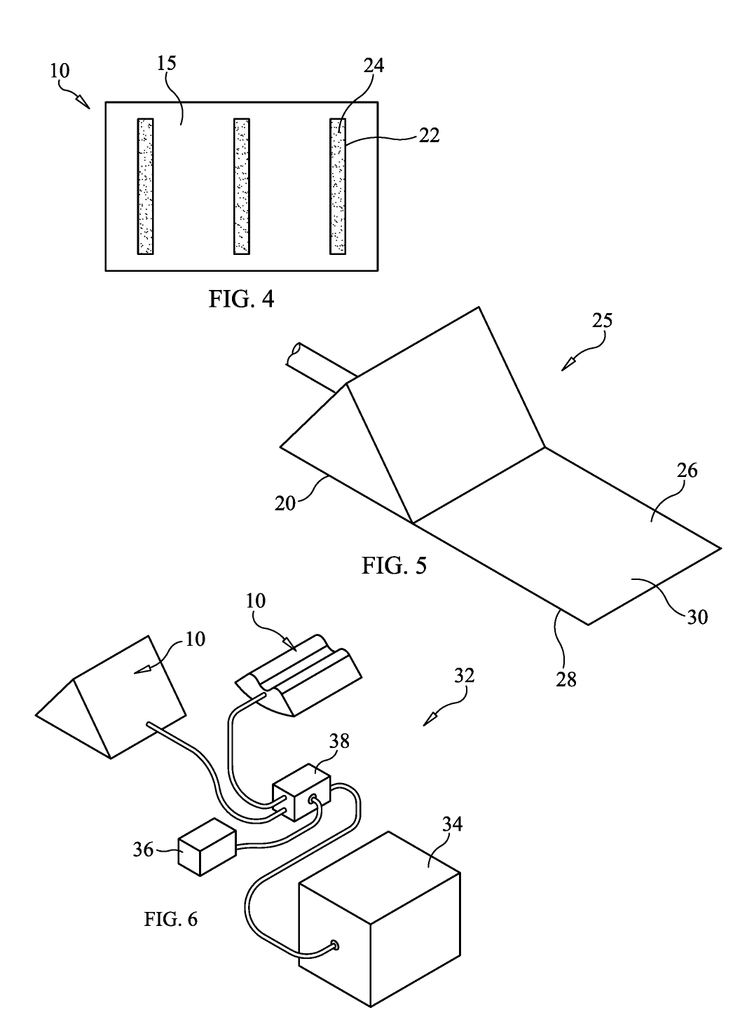

With reference to FIG. 4, a pressure sensitive adhesive strip 22 may be added to the bottom surface 15 of the inflatable positioner 10 or replace the high COF surface on the bottom surface 20 of the inflatable positioner 10. A non-stick label 24 is placed on top of the adhesive strip 22 to prevent premature adhesion.

With reference to FIG. 3, an inflatable positioner 10 is retained in a positioner bag 16. The positioner bag 16 is large enough to completely receive the inflatable positioner 10. The positioner bag 16 contains the inflatable positioner 10. The positioner bag 16 preferably includes a low coefficient of friction (COF) formed on a top surface 18 and a high COF formed on a bottom surface 20. The positioner bag 16 protects the inflatable positioner 10 from contamination. The positioner bag 16 is discarded after each patient use, instead of discarding a more expensive positioner. Further, the positioner bag 16 may be fabricated from a breathable material coated on at least one side to be a germ barrier. The breathable material may be a woven or non-woven fabric. An inside surface of the positioner bag would have a low COF impervious coated surface or a low COF impervious material placed on an inside of the positioner bag to allow easy insertion of the inflatable positioner 10. Finally, a plurality of micro holes 21 may be formed through the top surface 18 of the positioner bag 16. The plurality of micro holes 21 help dry a patient's skin. The plurality of micro holes 21 would leak a little air, while allowing the positioner to be inflated.

With reference to FIG. 5, a tail inflatable positioner 25 includes the inflatable positioner 10 with a positioner tail 26 extending from a bottom surface 15 of the inflatable positioner 10. The positioner tail 26 includes a length, which is at least as long as a length of the inflatable positioner 10. The positioner tail 26 is used to help insert the tail inflatable positioner 25 under the patient 100 and keep the inflatable positioner 25 in place. A low COF is formed a top surface 30 of the positioner tail 26 and a high COF is formed on a bottom surface 28 of the positioner tail 26. The positioner tail 26 is first inserted under the patient 100 and acts as an extension of the inflatable positioner 10. The positioner tail 26 could be made inflatable.

With reference to FIG. 6, a time operated inflation system 32 preferably includes an air pump 34, a timer 36 and a diverter valve 38. The time operated inflation system 32 is used to inflate at least one inflatable positioner 10. The diverter valve 38 includes one inlet and at least two outlets. The inlet of the diverter valve 38 is connected to an outlet of the air pump 34. If only one inflatable positioner 10 is used, one of the at least two outlets is preferably covered or sealed. The timer 36 provides electrical power to the diverter valve 38 to shuttle the diverter valve 38 from a first position to a second position. When in the first position, the air pump 32 inflates a first inflatable positioner 10 through a first outlet of the diverter valve 38. When in the second position, the air pump 32 inflates a second inflatable positioner 10 (if connected) through a second outlet of the diverter valve 38. The timer 36 may be programmed to provide a preferable inflation time between 10 minutes to 3 hours. It is preferable to have an alarm sound if the air pressure to one of the inflatable positioners 10 is too low.

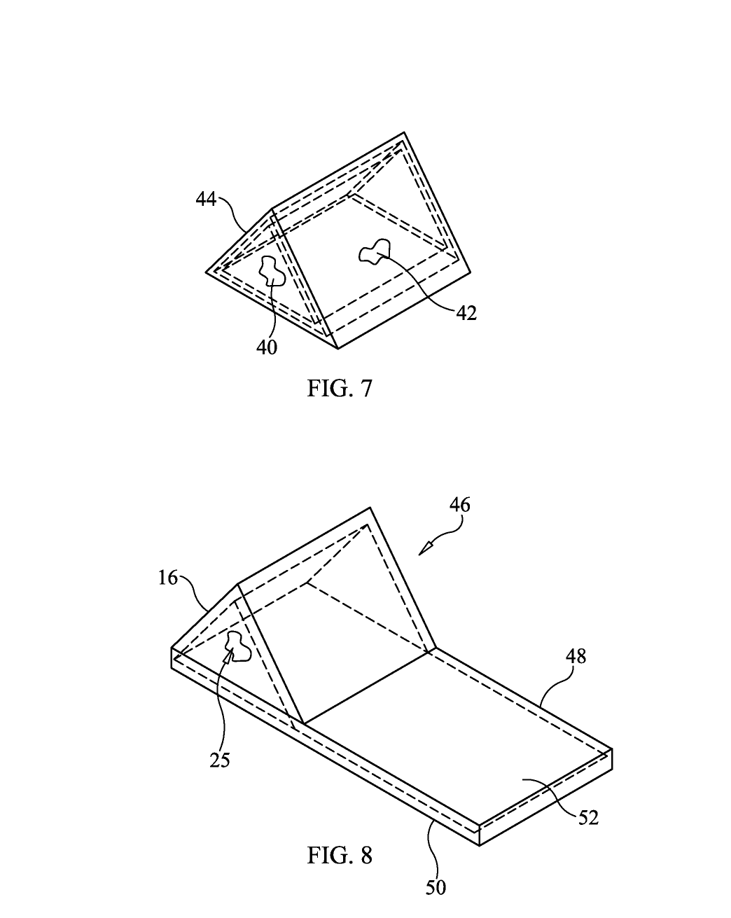

With reference to FIG. 7, non-inflatable positioners may be preferred over inflatable positioners by some caregivers or health care facilities. The non-inflatable positioners are made of foam, gel, or other materials. A non-inflatable positioner 40 is inserted into a high COF positioner bag 42 with an outer surface having a high COF. The high COF positioner bag 42 is inserted into a low COF positioner bag 44 having an outer surface with a low COF. After the low COF positioner bag 44 is inserted under the patient, the low COF positioner bag 44 is removed to expose the high COF bag 42. The high COF positioner bag 42 performs two functions. First, the high COF positioner bag keeps the non-inflatable positioner 40 clean, protecting it from germs, so it can be reused. Second, the high COF outer surface of the high COF positioner bag 42 holds it in place. The high COF positioner bag 42 should be kept sealed as long as it is used with the same patient. The low COF positioner bag 44 can be reused with the same patient by re-inserting the high COF positioner bag 42 and the non-inflatable positioner 40. The high and low COF positioner bags 42, 44 should be properly discarded between patients.

With reference to FIG. 8, a tail positioner bag 46 includes the positioner bag 16 with a tail bag 48 extending from one end of the inflatable positioner 10. The tail bag 48 is used to help insert the tail positioner bag 46 under the patient 100 and keep the tail positioner bag 46 in place. A low COF is formed a top surface 52 of the tail bag 48 and a high COF is formed on a bottom surface 50 of the tail bag 48. The tail inflatable positioner 25 is inserted into the tail positioner bag 46. The tail bag 48 is first inserted under the patient 100 and acts as an extension of the tail positioner bag 46. Additionally, there may be two tail bags, an inner bag would have a high COF outer surface and an outer bag would have a low COF outer surface. The tail inflatable positioner 25 is inserted into the inner bag and then the inner bag is inserted into outer bag, similar to FIG. 7.

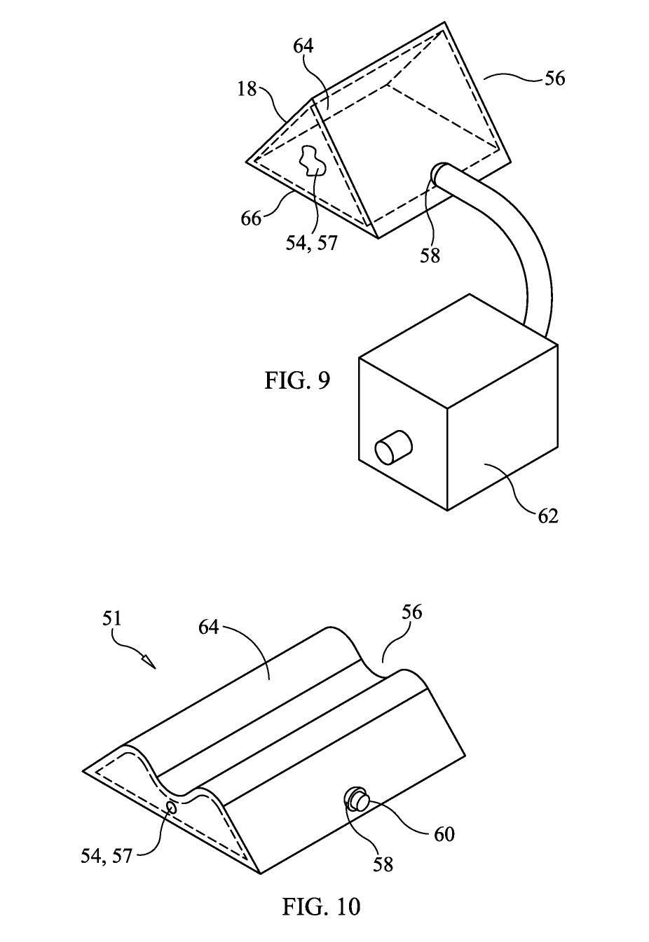

With reference to FIG. 9, a compressible positioner system 51 includes a compressible non-inflatable positioner 54 retained in a compressible positioner bag 56. The compressible positioner bag 56 includes an inner cavity 57, a port 58, which allows air to be evacuated from the inner cavity 57 through the port 58. The port 58 is sealed with a seal cap 60 to capture vacuum. A vacuum device 62 is used to create a vacuum inside the compressible positioner bag 56 and compress the compressible non-inflatable positioner 54 as shown in FIG. 10. A low COF surface is formed on a top surface 64 of the compressible positioner bag 56 and a high COF surface is formed on a bottom surface 66 of the compressible positioner bag 56. The compressed compressible positioner bag 56 is placed under a patient and the seal cap 60 removed to allow the compressible non-inflatable positioner 54 to return to its original shape.

The positioner bags 16, 25, 42, 44, 46 and 56 are preferably fabricated from an economical material, such as plastic film. The positioner bags 16, 25, 42, 44, 46 and 56 are discarded after one patient use. A preferred value of static low coefficient is less than 0.25. A preferred value of static high friction is greater than 0.45.

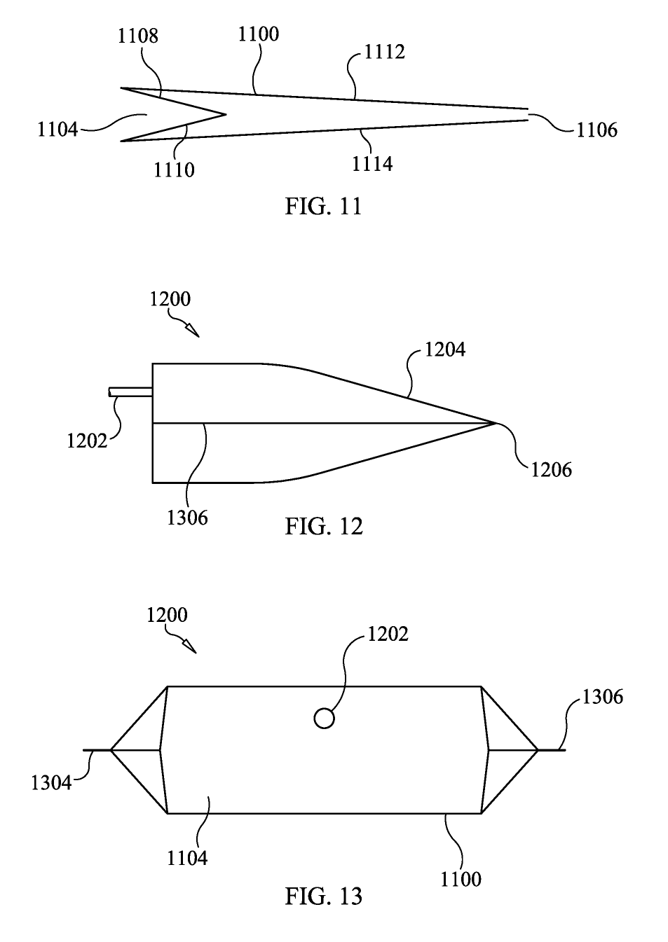

FIG. 11 shows a side view of a sheet of material 1100. With reference to FIG. 12, the sheet of material 1100 will be seamed to create a gusseted positioner 1200. The gusseted positioner 1200 includes a gusseted end 1104 and a non-gusseted end 1106, which is located on an opposing end of the gusseted positioner 1200. The gusseted end 1104 includes a first leg 1108 and a second leg 1110. One edge of the first leg 1108 extends from one edge of the second leg 1110. A first layer 1112 extends from an opposing edge of the first leg 1108. A second layer 1114 extends from an opposing edge of the second leg 1110. The first and second legs 1108, 1100 extend into a space between the first and second layers 1112, 1114, when a gusseted positioner body 1204 is uninflated. An inflation inlet 1202 is preferably formed in the gusseted end 1104 of the gusseted positioner 1200. The inflation inlet 1202 is preferably an inflation tube, but other suitable inflation inlets may also be used. An end seam 1206 is formed on the non-gusseted end 1106 to seal thereof. With reference to FIG. 13, side seams 1304, 1306 are formed on opposing sides of the sheet of material 1100 to form the positioner body 1204. Once all seams have been, made the gusseted positioner body 1204 may be inflated. The gusseted positioner 1200 when in inflated has a wedge shape. However, the first leg 1108, the gusseted end 1104 and the second layer 1114 may be fabricated from three separate pieces of material.

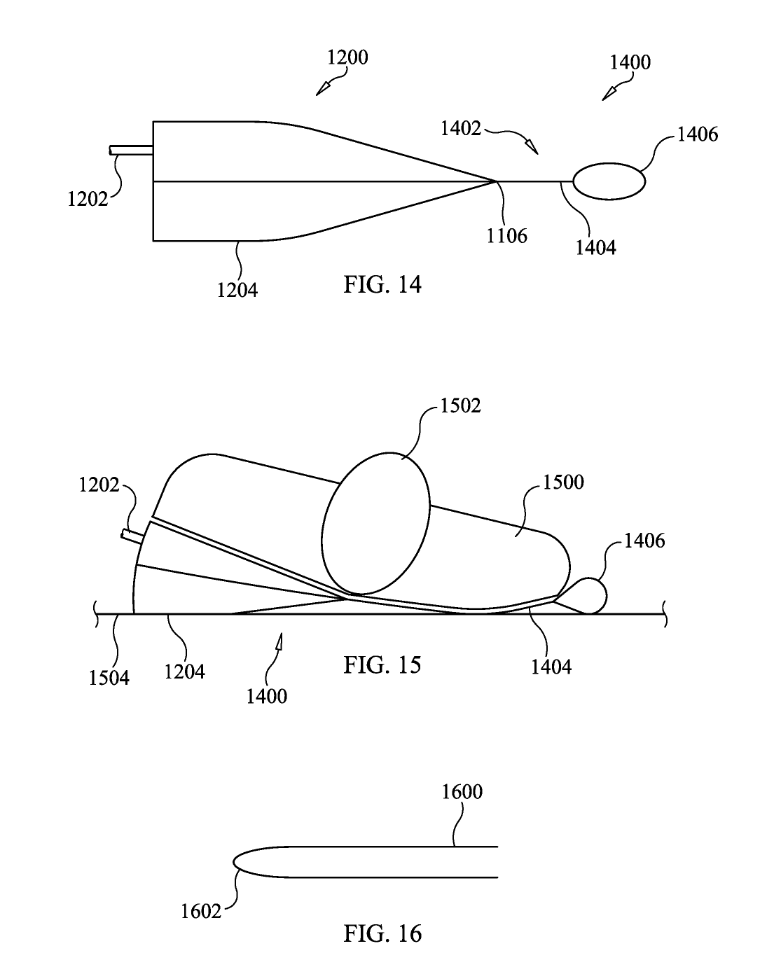

With reference to FIG. 14, a gusseted positioner with tail 1400 includes the gusseted positioner 1200 and a tail 1402. The tail 1402 extends from the non-gusseted end 1106 of the gusseted positioner 1200. The tail 1402 includes a tail portion 1404 and an anchor portion 1406. One end of the tail portion 1404 extends from the non-gusseted end 1106 and the anchor portion 1406 extends from an opposing end of the tail portion 1404. The tail portion 1404 may be a narrow strap or wider than a width of the positioner body 1204 or any width in between. A length of the tail portion 1404 and a distance of the anchor portion 1406 is field adjustable. The anchor portion 1406 may be field attached and detached. FIG. 15 shows an end view of a patient's torso 1500 and head 1502 resting on a side view of the inflated gusseted positioner with a tail 1400. A bed 1504 or the like supports the inflated gusseted positioner. An incontinence pad may be placed between the patient and the gusseted positioner with tail 1400.

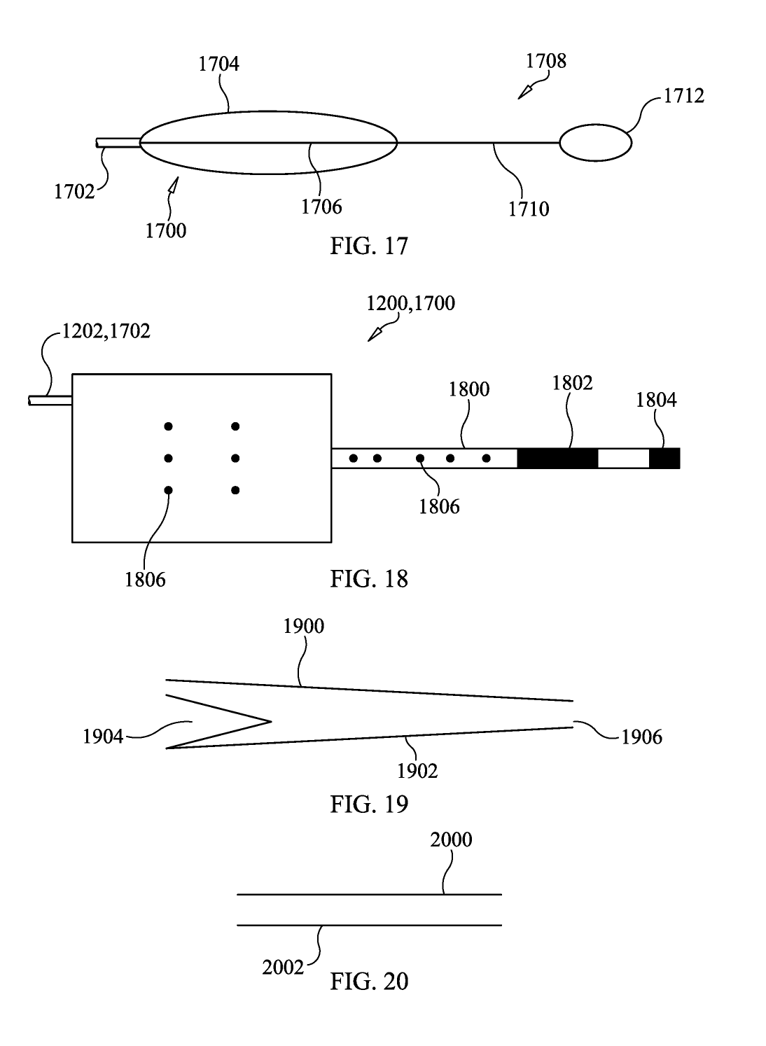

FIG. 16 shows a side view of a folded-over sheet of material 1600 with a closed end 1602. With reference to FIG. 17, the folded over sheet of material 1600 will be seamed on three open sides to create a positioner body 1704 for a positioner with a tail 1700. An inflation inlet 1702 is preferably formed in the closed end 1602 of the inflatable positioner 1700. A side seam 1706 seals one of the open sides. The positioner body 1704 includes a substantial pillow shape. With reference to FIG. 18, the positioner with tail 1700 includes the inflatable positioner 1700 and a tail 1708. The tail 1708 includes a tail portion 1710 and an anchor portion 1712. One end of the tail portion 1710 extends from an end opposite the closed end 1602 and the anchor portion 1712 extends from an opposing end of the tail portion 1710. The tail portion 1710 may be a narrow strap or wider than a width of the positioner body 1704 or any width in between. Preferably, the tail portion 1710 has a length of at least 125 mm. A length of the tail portion 1710 and a distance of the anchor portion 1712 is field adjustable. The anchor portion 1712 may be field attached and detached.

FIG. 18 shows a positioner 1200, 1700. A strap 1800 extends from the positioner body 1204, 1704. The strap 1800 extends from an end opposite the inflation inlet 1202, 1702. The strap 1800 may be tethered to a bed frame or other device to hold the positioner 1200, 1700 in place. The strap 1800 may be tied, or equipped with hook and loop fasteners, a snap, buckle or other attachment means to tether the strap 1800 to another object. A loop 1802 and a hook 1804 may be formed on the strap 1800. A plurality of vent perforations 1806 may be formed in the positioner 1200 or 1700 to let air flow out. If the plurality of vent perforations 1806 are formed in the positioner 1200, 1700, a pump must be connected to the inflation inlet 1202, 1702. The plurality of vent perforations 1806 have a preferred size of about 0.5 mm diameter. A plurality of vent perforations 1806 are also formed in the strap 1800 if an air passage is formed in the strap 1800 and if the strap material does not breathe. The positioner body 1204, 1704 may be fabricated from a breathable material, which would not require the plurality of vent perforations 1806.

FIG. 19 shows a side view of a top sheet of material 1900 positioned above a bottom sheet of material 1902. A gusset 1904 is formed in an end of the bottom sheet of material 1902. A perimeter of the top and bottom sheets of material 1900, 1902 are seamed to each other to form a gusseted positioner body. A non-gusseted end 1906 is created on an end opposite the gusset 1904. An air inlet is not shown. FIG. 20 shows a side view of a top sheet of material 2000 positioned above a bottom sheet of material 2002. A perimeter of the top and bottom sheets of material 2000, 2002 are seamed to each other to form a positioner body. The positioner body will have a substantial pillow shape. An air inlet is not shown.

The sheet of material 1100, 1600, 1900, 1902, 2000 and 2002 have a preferred coefficient of friction, which is no greater 0.25. If the sheet of material 1100, 1600, 1900, 1902, 2000 and 2002 or strap 1800 is breathable, the material preferably has a Moisture Vapor Transfer Rate measured by ASTM E96 procedure B of 500 grams/square meter/day or greater. An uninflated positioner body 1204, 1704 preferably has a thickness of no greater than 5 mm.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. An inflatable positioner comprising:
a positioner body having an upper surface and a lower surface, an inflation inlet is formed in said positioner body; and
a tail having a tail portion and an anchor portion, said tail portion extends from said positioner body, said anchor portion is retained on said tail portion.

2. The inflatable positioner of claim 1 wherein:
a gusset is formed in said positioner body, said gusset includes a first leg and a second leg, one edge of said first leg extends from one edge of said second leg, a first layer of said positioner body extends from an opposing edge of said first leg, a second layer of said positioner body extends from an opposing edge of said second leg, said first and second legs extend into a space between said first and second layers.

3. The inflatable positioner of claim 1 wherein:
said positioner body is fabricated from one of a single sheet of material and two sheets of material.

4. The inflatable positioner of claim 1 wherein:
said positioner body is fabricated from one of a breathable material and a non-breathable material, if said positioner body is fabricated from a non-breathable material, a plurality of vent perforations are formed through said non-breathable material.

5. The inflatable positioner of claim 1 wherein:
said tail portion is fabricated from one of a breathable material and a non-breathable material, if said tail portion is fabricated from a non-breathable material, a plurality of vent perforations are formed through said non-breathable material.

6. The inflatable positioner of claim 1 wherein:
said tail has a length of at least 125 mm.

7. The inflatable positioner of claim 1 wherein:
a thickness of said positioner body when uninflated has a thickness of no more than 5 mm thick.

8. The inflatable positioner of claim 1 wherein:
said anchor portion is either factory or field removably attached.

9. The inflatable positioner of claim 1 wherein:
said tail is wider or narrower than a width of said positioner body.

10. The inflatable positioner of claim 1 wherein:
at least one of said upper and lower surfaces have a coefficient of friction of no more than 0.25.

11. An inflatable positioner comprising:
a positioner body having an upper surface and a lower surface, an inflation inlet is formed in said positioner body; and
a strap extends from said positioner body, wherein said strap is capable of being secured to another object.

12. The inflatable positioner of claim 11 wherein:
a gusset is formed in said positioner body, said gusset includes a first leg and a second leg, one edge of said first leg extends from one edge of said second leg, a first layer of said positioner body extends from an opposing edge of said first leg, a second layer of said positioner body extends from an opposing edge of said second leg, said first and second legs extend into a space between said first and second layers.

13. The inflatable positioner of claim 11 wherein:
said positioner body is fabricated from one of a single sheet of material and two sheets of material.

14. The inflatable positioner of claim 11 wherein:
said positioner body is fabricated from one of a breathable material and a non-breathable material, if said positioner body is fabricated from a non-breathable material, a plurality of vent perforations are formed through said non-breathable material.

15. The inflatable positioner of claim 11 wherein:
said strap is fabricated from one of a breathable material and a non-breathable material, if said strap is fabricated from a non-breathable material, a plurality of vent perforations are formed through said non-breathable material.

16. The inflatable positioner of claim 11 wherein:
a thickness of said positioner body when uninflated has a thickness of no more than 5 mm thick.

17. The inflatable positioner of claim 11 wherein:
at least one of said upper and lower surfaces have a coefficient of friction of no more than 0.25.
